(19) United States
(12) Patent Application Publication
(10) Pub. No.: US 2015/0038628 A1
(43) Pub. Date: Feb. 5, 2015

(54) FREE-FLOWING SLURRIES OF SMALL PARTICLES OF AN ALKALI OR ALKALINE EARTH METAL BOROHYDRIDE

(71) Applicant: Rohm and Haas Company, Philadelphia, PA (US)

(72) Inventors: Michael Bender, Willow Grove, PA (US); Robert Butterick, III, Swedesboro, NJ (US); Edward C. Kostansek, Asheville, NC (US); Samuel November, Newtown, PA (US); John Yamamoto, Doylestown, PA (US)

(73) Assignee: Rohm and Haas Company, Philadelphia, PA (US)

(21) Appl. No.: 14/374,246

(22) PCT Filed: Jan. 31, 2013
(86) PCT No.: PCT/US13/24088

§ 371 Date: Jul. 24, 2014

Related U.S. Application Data
(60) Provisional application No. 61/594,464, filed on Feb. 3, 2012.

(51) Int. Cl. C01B 6/04

(52) U.S. Cl. CPC C01B 6/04
USPC 524/404; 516/33

(57) ABSTRACT

A method for dispersing an alkali or alkaline earth metal borohydride having median particle size less than 30 microns in an organic solvent. The method comprises combining the alkali or alkaline earth metal borohydride, the organic solvent and a surfactant.

This invention relates to a free-flowing slurry containing small particles of an alkali or alkaline earth metal borohydride.

Suspensions of sodium borohydride in solvents are known. For example, US2010/0196242 discloses suspensions of sodium borohydride in solvents, typically hydrocarbons or natural oils or fats. However, this reference discloses nothing regarding the small particles of sodium borohydride used in the present invention.

The problem addressed by this invention is to produce a free-flowing slurry containing small particles of an alkali or alkaline earth metal borohydride.

### STATEMENT OF INVENTION

The present invention provides a method for dispersing an alkali or alkaline earth metal borohydride having median particle size less than 30 microns in a solvent. The method comprises combining: (i) the alkali metal borohydride, (ii) the solvent and (iii) a surfactant comprising an anionic surfactant, a polymerized alkyl pyrrolidone surfactant, or a combination thereof.

The present invention is further directed to a composition comprising an alkali or alkaline earth metal borohydride having median particle size less than 30 microns, a solvent and at least one of an anionic surfactant and a polymerized alkyl pyrrolidone surfactant.

### DETAILED DESCRIPTION

Percentages are weight percentages (“wt %”) and temperatures are in ° C., unless specified otherwise. “Room temperature” is the ambient indoor temperature, typically 20-25° C. Median particle size is determined using a MALVERN MASTERSIZER 2000 with a 2000 μP Module. Samples are manipulated in dry nitrogen atmospheres and mixed with a solvent, e.g., p-xylene, containing a nonionic surfactant, e.g., NINATE 60 L at ca. 0.15 wt %, with an alkali metal borohydride concentration of ca. 1 wt %, and sonicated for four minutes. An “organic solvent” is a compound or mixture of compounds containing carbon atoms which is liquid at 20-25° C. at normal atmospheric pressure (101 kPa). Preferred organic solvents include hydrocarbons and ethers, preferably hydrocarbons and aliphatic ethers, preferably hydrocarbons. Especially preferred organic solvents include, e.g., xylene mixtures and p-xylene.

Preferably, the surfactant is an anionic surfactant, preferably one having a sulfonate or carboxylate functional group. Preferable anionic surfactants include, e.g., sodium alkylbenzenesulfonates (linear or branched), linear sodium alpha olefin sulfonates, sodium alkane sulfonates, sodium lauroyl lactylates, sodium alkylbenzene carboxylates, sodium alkyl carboxylates, and potassium or calcium salts of the aforementioned compounds. Preferably, the surfactant has an alkyl group having at least eight carbon atoms, preferably at least ten carbon atoms, preferably at least twelve carbon atoms. Preferably the surfactant is added in an amount from 0.01 wt % to 0.5 wt %, based on total weight of the slurry; preferably at least 0.03 wt %, preferably at least 0.05 wt %, preferably at least 0.07 wt %, preferably at least 0.09 wt %, preferably no more than 0.4 wt %, preferably no more than 0.3 wt %, preferably no more than 0.2 wt %.

Preferably, the alkali or alkaline earth metal borohydride is present in the composition in an amount from 0.1 wt % to 5 wt %, preferably at least 0.3 wt %, preferably at least 0.5 wt %, preferably no more than 4 wt %, preferably no more than 4 wt %, preferably no more than 3 wt %, preferably no more than 2 wt %, preferably no more than 1.5 wt %. Preferably, the alkali metal borohydride is ground in the presence of both the organic solvent and the surfactant.

Preferably, the alkali or alkaline earth metal borohydride contains fumed silica and/or magnesium carbonate, preferably prior to grinding. “Fumed silica” is silica produced by pyrolysis of silicon compounds at high temperatures. Typical specifications are as follows: average particle size is 5-50 nm; surface area is 50-600 m²/g; density 160-190 kg/m³.

Preferably, average particle size is 10-40 nm; surface area is 75-500 m²/g. Preferably, magnesium carbonate used in the method of this invention has a water content no more than 1 wt %, preferably no more than 0.5 wt %, preferably no more than 0.2 wt %, preferably no more than 0.1 wt %. Preferably, magnesium carbonate has an average particle size prior to grinding from 1 micron to 50 microns, preferably from 10 microns to 40 microns.

Preferably, fumed silica, magnesium carbonate, or a combination thereof is added to the alkali or alkaline earth metal borohydride in a total amount from 0.5 wt % to 7 wt %, based on total weight of the composition; preferably at least 0.7 wt %, preferably at least 0.8 wt %, preferably at least 0.9 wt %, preferably at least 1 wt %; preferably no more than 6 wt %, preferably no more than 5.5 wt %, preferably no more than 5 wt %, preferably no more than 4.5 wt %, preferably no more than 4 wt %, preferably no more than 3.5 wt %. Preferably, the solid composition comprising an alkali or alkaline earth metal borohydride is ground to a median particle size of less than 25 microns, preferably less than 20 microns, preferably less than 15 microns, preferably less than 12 microns. Preferably the solid composition is ground to a median particle size no less than 2 microns, preferably no less than 3 microns, preferably no less than 4 microns. Preferably, the alkali or alkaline earth metal borohydride contains no additives.

Preferably, the alkali or alkaline earth metal borohydride is an alkali metal borohydride or calcium borohydride; preferably sodium borohydride, potassium borohydride, calcium borohydride or lithium borohydride; preferably sodium borohydride, potassium borohydride or lithium borohydride; preferably sodium borohydride or potassium borohydride; preferably sodium borohydride. Preferably, the alkali or alkaline earth metal borohydride has an average particle size prior to grinding from 50 microns to 1000 microns, preferably from 100 microns to 300 microns. Preferably, the alkali or alkaline earth metal borohydride prior to grinding has no more than 1 wt % water, preferably no more than 0.5 wt %, preferably no more than 0.2 wt %, preferably no more than 0.1 wt %.

Preferably, the water content of the composition comprising an alkali or alkaline earth metal borohydride is no more than 0.5%, preferably no more than 0.2%, preferably no more than 0.1%. Preferably, the composition contains less than 5% of anything other than the alkali metal borohydride, organic solvent, surfactant, silica and magnesium carbonate, preferably less than 3%, preferably less than 2%, preferably less than 1%, preferably less than 0.5%.

Preferably, the solid composition is ground in a mill capable of producing particles having a median particle size less than 50 microns, e.g., fluid energy mills (fluidized jet mill, spiral jet mill), ball mills (vibration, centrifugal, gravity), wet media mills (stirred media mill). Preferably, the parts of the mill which contact the solid composition are made of stainless steel. Preferably, milling is done at a temperature from 0° C. to 100° C., preferably from 10° C. to 40° C. Preferably, the mill is cooled by a cooling jacket to maintain temperature in the aforementioned ranges. Preferably, the milling time in a ball mill is from 1 minute to 2 hours; preferably at least 2 minutes, preferably at least 5 minutes, preferably at least 10 minutes; and preferably the milling time is no more than 1.5 hours, preferably no more than 1 hour, preferably no more than 50 minutes, preferably no more than 40 minutes. The number and size of the balls and the rotation rate can easily be determined by those of skill in the art depending on the target particle size. Preferably, grinding in jet mills is controlled by pressure. In a spiral jet mill the pressure preferably is at least 30 psig (300 kPa), preferably at least 50 psig (440 kPa), preferably no more than 250 psig (1800 kPa). In a fluidized bed jet mill, preferably the pressure is from 2-18 atmospheres (200-1800 kPa), preferably from 4-15 atmospheres (400-1500 kPa). Feed rates and the number of passes through the jet mills can easily be determined by those of skill in the art depending on the target particle size.

### EXAMPLES

### Example 1

The traditional method of particle size analysis of sodium borohydride (SBH) is the use of a laser light scattering method using mineral oil as the dispersant solvent. This method is inadequate for measuring ultra small particles of sodium borohydride (<40 um) because of the tendency of this material to agglomerate in a liquid medium. Therefore we added dispersants to our solvent system, with the following results.

A dispersion of sodium borohydride in anhydrous p-xylene with 0.05 wt % Hexaethylene Gycol Monodecyl Ether contained only aggregated material. Similar behavior occurred with wet xylenes and in mineral oil.

A dispersion of sodium borohydride was prepared in anhydrous p-xylene with 15 wt % (based on weight of SBH) of NINATE™ 60 L surfactant (60% solids non-aqueous linear calcium alkylbenzenesulfonate, available from Stepan Co.). Similar results were obtained with wet xylenes with 15 wt % NINATE™ 60 L surfactant.

TABLE 1
Particle Size Analysis of Hosokawa Jet Milled Material.

| | D₁₀ (μm) | D₅₀ (μm) | D₉₀ (μm) |
|---|---|---|---|
| wet xylenes | 3.67 | 11.46 | 42.75 |
| anhydrous p-xylene with 0.05 wt % | 8.82 | 15.46 | 28.06 |
| hexaethylene glycol monodecyl ether, | | | |
| not stable | | | |
| anhydrous p-xylene with 15 wt % | 0.18 | 8.41 | 17.42 |
| NINATE ™ 60 L | | | |

### Analysis Parameters:

The samples were manipulated in dry inert nitrogen atmospheres until the well mixed with the solvent containing the dispersant.
Malvern Mastersizer 2000 with 2000μP Module
Solvent: anhydrous p-xylene or wet xylene
Concentration SBH: ˜1 wt %
Dispersant 0.15 Wt % NINATE 60 L
4 min sonication
   Samples analyzed while pumped at 1800 RPM with no sonication.

Milled sodium borohydride was dispersed in xylenes at 1 wt % sodium borohydride with combinations of NINATE™ 60 L and AGRIMER™ AL-22 (poly(vinylpyrrolidone) with 80% C-16 alkylation, available from ISP Corp.).

| Surfactant | % of slurry | result |
|---|---|---|
| NINATE ™ 60 L | 0.15% | well dispersed (at most a few small |
| | | aggregates) |
| hexaethylene glycol | 0.05% | not dispersed - large aggregates |
| monodecyl ether | | |
| NINATE ™ 60 L | 0.05% | partially dispersed - many small |
| AGRIMER ™ AL-22 | 0.05% | aggregates |
| NINATE ™ 60 L | 0.1% | well dispersed (at most a few small |
| AGRIMER ™ AL-22 | 0.05% | aggregates) |
| NINATE ™ 60 L | 0.15% | well dispersed (at most a few small |
| AGRIMER ™ AL-22 | 0.05% | aggregates) |
| AGRIMER ™ AL-22 | 0.05% | partially dispersed - many small |
| | | aggregates |

### Example 2 (Comparative)

The feasibility of slurry milling was evaluated through a scouting experiment in an Eiger bead mill using preground VENPURE™ SF powder (D₅₀ of 45 μm). Under ambient N₂ atmosphere, 92.0 grams of 0.9 to 1.1 mm ZIRMIL CE beads (ceramic beads, available from Saint-Gobain) and 26.2 grams of powder and 152.6 g of pure xylene without surfactant were added to the mill Samples were milled at 4000 rpm (agitator outside diameter=3.5 inches). Two 10 mL samples were removed from the system at 10 min intervals via a syringe. After the 20 minute sample was taken and the mill speed was increased to continue milling, the mill seized due to agglomeration of the SBH and beads. This kind of agglomeration when milling with a stirred media mill is not uncommon. It is thought to occur through a combination of high slurry solids level, shearing thickening action and temperature. Often it can be overcome by formulating the slurry with the right combination of surfactants and disperants. The results of this experiment are reported below.

TABLE 2
Particle size analysis (μm) of Eiger milled sodium borohydride.

| | Starting Material | 10 mins | 20 mins |
|---|---|---|---|
| D₉₀ | 62.3 | 12.0 | 14.8 |
| D₅₀ | 15.4 | 4.6 | 0.45 |
| D₁₀ | 0.18 | 1.1 | 0.10 |
| Vol wt. mean | 25.5 | 5.6 | 4.2 |

*Particle size data obtained using the laser particle size method using xylene and NINATE 60L as the solvent.

1. A method for dispersing an alkali or alkaline earth metal borohydride having median particle size less than 30 microns in an organic solvent; said method comprising combining: (i) said alkali or alkaline earth metal borohydride, (ii) the organic solvent and (iii) a surfactant comprising an anionic surfactant, a polymerized alkyl pyrrolidone surfactant, or a combination thereof.

2. The method of claim 1 in which the organic solvent is a hydrocarbon solvent.

3. The method of claim 2 in which the surfactant is an anionic surfactant.

4. The method of claim 3 in which the alkali or alkaline earth metal borohydride is sodium borohydride.

5. The method of claim 4 in which median particle size of the composition is from 2 microns to 25 microns.

6. The method of claim 5 in which the sodium borohydride is ground in a fluidized jet mill or pancake jet mill.

7. A composition comprising an alkali or alkaline earth metal borohydride having median particle size less than 30 microns, a solvent and at least one of an anionic surfactant and a polymerized alkyl pyrrolidone surfactant.

8. The composition of claim 7 in which the organic solvent is a hydrocarbon solvent.

9. The composition of claim 8 in which the surfactant is an anionic surfactant.

10. The composition of claim 9 in which median particle size of the composition is from 2 microns to 25 microns.
